(19) United States
(12) Patent Application Publication
(10) Pub. No.: US 2014/0224157 A1
(43) Pub. Date: Aug. 14, 2014

(54) COMPOSITE UNDERGROUND MUNITIONS VAULT

(71) Applicant: Walton W. McCarthy, Forney, TX (US)

(72) Inventor: Walton W. McCarthy, Forney, TX (US)

(21) Appl. No.: 13/767,466

(22) Filed: Feb. 14, 2013

(51) Int. Cl. E05G 1/024

(52) U.S. Cl. CPC E05G 1/024
USPC 109/78

(57) ABSTRACT

The present invention is a composite munitions vault adapted for use underground. The munitions vault includes a watertight, non-corrosive, composite hull. The hull includes an upper section with a top, two short sides, and two long sides, where each of the two short sides and two long sides have a hexoid shape, and the upper section has no flat surfaces. The hull also includes a lower section with a convex bottom and a gravity ring spanning the circumference of the vault between the upper and lower sections.

### FIELD OF THE INVENTION

The present invention relates to underground disaster shelters and, in particular, to improved structural elements therefore.

### BACKGROUND

In spite of a large amount of misinformation which has been presented to the public, there is convincing scientific and technical information available that it is possible for most people to survive a full scale exchange of nuclear, biological, or chemical weapons, or disaster caused by an industrial accident, provided that proper advance preparations are made.

It is acknowledged that there would be little incentive for an individual to survive such a nuclear holocaust or biological disaster if, as a result, all life on earth were doomed to extinction or marginal existence. However, the National Academy of Sciences (NAS) has produced extensive reports on the atmospheric effects from various war scenarios, which contradict the likelihood any such idea. In reality, therefore, the question today is not whether persons can survive nuclear, biological, and chemical warfare or disaster agents, but whether people have the will and determination to prepare for survival.

A number of underground disaster shelters have been developed in preparation of such a disaster. The ability of such a shelter to adequately protect one or more individuals depends on many factors, such as its equipment to provide the shelterists with fresh, uncontaminated air; its ability to dispose of and store waste; its food stocks; and of course, the integrity of the shelter itself. The shelter needs to be strong enough to withstand not only extreme above ground external forces, such as nuclear or High Altitude Electromagnetic Pulse (HEMP) weapons, and inter-earth forces, such as earthquakes, but also the everyday force of the weight of earth above the shelter, and to withstand these forces without corrosion or other degradation of shelter materials.

Electromagnetic Pulse (EMP) is created by nuclear weapons detonated at altitudes of 40+ miles above ground. HEMP damage electrical and electronic circuits by inducing voltages and currents that they are not designed to withstand. EMP induces large voltage and current transients on electrical conductors such as antennas and wires as well as conductive tracks on electronic circuit boards. When EMP pulses enter a system through a path designed to gather electromagnetic energy, such as an antenna, they are said to have entered through the front door. In contrast, when they enter through an unplanned path, such as cracks, seems, trailing wires or conduits, they have entered through the back door. The efficiency of the energy transfer from pulse to system depends upon the frequency compatibility between the pulse and the entry path and on the conductivity of the material. In general, sophisticated integrated circuits with short signal paths are susceptible to high frequency pulses while large electrical systems, such as commercial power characterized by long transmission lines, are vulnerable to low frequency EMP. It follows that a broadband EMP weapon threatens a greater number of systems than a narrowband weapon, though the power requirement for a broadband weapon is much higher. Regardless of how EMP enters a system, it damages components simply by overloading them.

An EMP is composed of three components. The first (E1) is a high frequency (1 mHz-1 gHz) free-field energy pulse with a rise time of a few billionths of a second. This component disrupts or damages electronics-based control systems, sensors, communications systems, computers, and similar devices. The second component (E2) is a medium frequency pulse, similar to lightning, that follows E1 by a few millionths of a second. The E2 component is not particularly dangerous to electronics, especially those hardened against lightning, except when the E1 pulse damages surge protection circuitry first. The third component is a relatively low frequency (3-30 Hz) slower rising pulse that follows E2 by a couple thousandths of a second and creates disruptive currents in long transmission lines. The sequence of E1, E2, and E3 is important, because each causes damage building on the preceding pulse.

Several underground shelter systems exist including several of the inventor's. These include the inventor's disaster shelters disclosed in U.S. Pat. Nos. 6,438,907 and 6,385,919, and U.S. patent application Ser. No. 11/373,431. Although each of these disaster shelters is an excellent structure, still stronger structures and structures capable of withstanding EMPs for disaster shelters are desirable.

### SUMMARY OF THE INVENTION

The present invention includes extruded hexoid ribs with convex half-hexagon cross-sections, a shelter substructure, extruded hexoid shelters, and a shelter with a copper mesh infused hull.

The first rib of the present invention is a half-hexoid rib. The half-hexoid rib may be a single piece forming a 180° half-hexoid arch, but preferably spans only 90° so that two first ribs are required to form an entire half-hexoid arch. Having noted the possibility of the half-hexoid rib being a single piece forming a full half-hexoid arch, hereinafter, “first rib” refers to the preferred rib that spans only 90°, or half of a half-hexoid arch, and “arch” refers to the sealed combination of two first ribs that spans the full 180°.

The first rib is a modification of a conventional elliptical rib. Instead of a standard elliptical curve, the first rib has been pushed out or extruded at the sides, making the structure slightly more square or rectangle. The inventor has blended several radii into a fillet blend radius so that the bottom part of the first rib is almost a vertical wall, but is still curved. How far the sides are extruded is further guided by superimposing a half-hexagon over a standard half-ellipse, where the half-hexagon is half of a hexagon with all 120° angles, and a longest distance between opposite vertices equal to the major axis of the half-ellipse. The extruded shape of the arch is made by beginning and ending at the same points as the standard half-elliptical shape, reaching the same maximum height of the half-ellipse between those points, but connecting the curve to intersect with the half-hexagon's vertices, rather than following the curve of the half-ellipse. The fillet blend produces the desired shape. As its shape is guided by a half-hexagon, but is smooth and without flat surfaces or points, we call this shape a “half-hexoid” shape. Pushing or extruding the wall out so that it is almost vertical provides much more room within the shelter structure of which the first rib is a part. Preventing it from being extruded all the way to vertical so that the wall is still curved, however, ensures that there are no tensile loads on the wall and places the structure in buckling mode. The half-hexoid arch, formed by two first ribs, uses only slightly more material than a conventional half-elliptical arch, but is much stronger and provides much more usable space within the shelter structure of which the arch is a part.

The first rib includes a base end and a top end. The base end will attach to a base, which is a part of the substructure of the shelter structure, discussed below. The top end is at the height of the first rib and is where two first ribs will be sealed to form a half-hexoid arch. The preferred arch has a horizontal span, where half of the span is approximately 1.1 to 1.5 times that of the vertical height. To be specific, the floor between the base ends of the arch, which is the span, is about 52 feet wide, and the distance between the floor and the ceiling halfway between the base ends is about 20 feet high, which is the height.

The second rib of the present invention is a full hexoid rib. The second rib of the present invention is therefore the equivalent of four first ribs together to form an entire extruded hexoid shape that is all one piece. The second rib has the same modified elliptical/hexagonal hybrid shape as the first rib in that the classic elliptical shape has been pushed out using a hexagon as guidance to create almost vertical sides, but has all curved surfaces. The second rib therefore also creates much more room within its shape as compared to a non-extruded ellipse, but is also stronger. The preferred second rib has a horizontal span of 14 feet and a vertical total height of 11 feet. As the floor within the second rib is not necessarily positioned at the halfway point of the total height of the second rib, however, the ceiling is preferably approximately 8⅓ feet tall.

The first and second ribs have a cross-section that is shaped like a convex half-hexagon that has no flat surfaces. The convex half-hexagon cross-sectional shape and the extruded elliptical/hexoid shape of the overall rib make for a very strong structure. As with the overall hexoid shape, the lack of flat surfaces of the convex half-hexagon cross-section of the ribs means that all of the earth loads on the rib surfaces are compressive, rather than tensile. The curved surfaces of the convex half-hexagon cross-section of the ribs are curved just enough to prevent “snap through” or inward bending. As this is a fairly high threshold, the curves are fairly broad. As such, minimal extra material is required to form the convex half-hexagon cross-section, as compared to an actual half-hexagon cross-section with flat sides. The convex half-hexagon cross-section of the preferred first rib is 12 feet wide, which is about ¼ the span of the arch, which is preferably 52 feet, as discussed above. Although the preferred cross-sectional width of the first rib is 12 feet, the width may be between 12 and 16 feet. The convex half-hexagon cross-section of the preferred second rib is 4 feet, which is about ¼ the span of the second rib, which is preferably 14 feet, as discussed above. The ratio of cross-section width to span is preferably between 0.22 and 0.31.

The convex half-hexagon cross-section of the first and second ribs preferably includes a base flange extending outwardly from the bottom of either side of the cross-section. A lip flange preferably extends perpendicularly upward from the base flange. The lip flanges of adjacent ribs are designed to meet and be sealed to one another so as to adjoin the adjacent ribs. The sealing is achieved with a firm ethylene propylene diene monomer (EPDM) rubber gasket and bolts. This sealing is used along the length of adjacent ribs at the lip flanges. It is also used to secure the tops of first ribs to form an arch.

The first and second ribs are preferably made using a polyester resin with between 65 and 75% glass content, and preferably approximately 70%. As glass bends, and resin is stiff, the inventor has found that using 70% glass in resin results in the desired flexibility and resilience profile for the laminate. The designated glass content also makes the laminate fire resistant. The preferred process used to mold the ribs is called the vacuum infusion process. With this process, all the glass is laid down in full thickness, a bag is placed over the entire rib, a full vacuum is drawn on the glass over the mold, and then the polyester resin is sucked into the laminate. Whether or not the vacuum infusion process is used to mold the ribs, it is preferred that an inner layer of the ribs contain a fine copper mesh. The preferred copper mesh has at least 12 strands per inch, is preferably 16 mesh solid copper, and is typically used for electromagnetic fields and RF frequencies. The copper mesh is preferably approximately 0.060 inches from the inside surface of the shelter hull. The copper mesh is between 0.75 and 0.85 inches from the inside surface of the shelter hull, and preferably 0.80 inches. Although a copper mesh EMP shield is presented herein specifically with respect to the shelter structures formed by the first and second ribs of the present invention, it is understood that the inclusion of copper mesh in the hull of any disaster shelter structure as an EMP shield is considered part of the present invention.

The first ribs of the present invention are designed for use with the substructure of the present invention. The substructure of the present invention is a substructure for the shelter structure of the present invention that is formed of the first ribs of the present invention. In its most basic form, the substructure of the present invention includes at least one composite, precast base or precast concrete that is resin coated. It is an advantage to have precast bases as less construction must be done in the field. The base includes two pedestals, each of which has a top, a bottom, a height between the top and bottom, and an inner and outer side. At least the tops of the pedestals are coated in fiberglass. The tops of the pedestals are sized and equipped to affix the base ends of first ribs of the present invention. Holes are preferably drilled into the pedestals so that expanding anchor bolts may be used to secure the base ends of the first ribs to the pedestals. The inner sides of the pedestals face toward the inside of the shelter structure. The outer sides of the pedestals face away from the inside of the shelter structure.

It is preferred that the inner sides of the tops of the pedestals include a lip on which a fiberglass corrugated floor segment may rest. The fiberglass corrugated floor segment is preferably made of two equally sized floor panels. The floor panels are bolted together with gaskets and all seams along and between the floor panels and the pedestals are sealed with a flexible sealant to create a gas tight foundation and floor. This gas tight surface prevents radon and methane gas, commonly found in underground structures, from entering the shelter. When more than one base is used, there are ¼ inch spaces between adjacent pedestals. During ground shock, as each arch has a designated base, and each base is separated by ¼ inch, arches are somewhat isolated and therefore have more room to articulate. A recess is formed under the floor based on the height of the pedestals. This recess can be used to house air ducts, plumbing, electrical lines, and sump pumps, and other shelter infrastructure.

In its most basic form, the half-hexoid shelter structure of the present invention includes at least two first ribs of the present invention, a substructure of the present invention, and two end panels. The end panels are sized and dimensioned to mate with the first ribs. The end panels seal along the lip flanges of the first ribs' cross-sections, just as adjacent first ribs are sealed to one another.

In its most basic form, the hexoid shelter structure of the present invention includes one or more second ribs and two end panels. In hexoid shelters including more than one second rib, the second ribs are sealed together along the lip flanges of the adjacent second ribs' cross-sections. The end panels are sized and dimensioned to mate with the second ribs. The end panels seal along the lip flanges of the second ribs' cross-sections, just as adjacent second ribs are sealed to one another.

Therefore it is an aspect of the present invention to provide ribs of a shelter structure that include a half-hexoid or hexoid shape.

It is a further aspect of the present invention to provide ribs with a cross-section with a convex half-hexagon shape.

It is a further aspect of the present invention to provide a disaster shelter that is stronger than its prior art counterparts.

It is a further aspect of the present invention to provide a superior shelter substructure including a gas tight floor and a recess beneath the gas tight floor for housing shelter infrastructure.

It is a further aspect of the present invention to provide a precast composite base having significant advantages over prior art fiberglass and concrete bases.

It is a further aspect of the present invention to provide a rib, arch, and therefore hull of a shelter structure including an inner layer including copper mesh, thus protecting the shelter structure from EMPs.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a perspective view of a first rib of the present invention.

FIG. 2 is a front view of a prior art elliptical arch for a disaster shelter.

FIG. 3 is a front view of a half-hexoid arch of the present invention.

FIG. 4 is a diagram of how the half-hexoid shape of the ribs of the present invention is defined.

FIG. 5A is a cross-sectional view of a rib of the present invention.

FIG. 5B is cross-sectional view of several ribs of the present invention.

FIG. 6 is a perspective view of a disaster shelter structure of the present invention using first ribs.

FIG. 7 is a cutaway view of a prior art disaster shelter.

FIG. 8 is a cutaway view of a disaster shelter structure of the present invention using second ribs.

### DETAILED DESCRIPTION

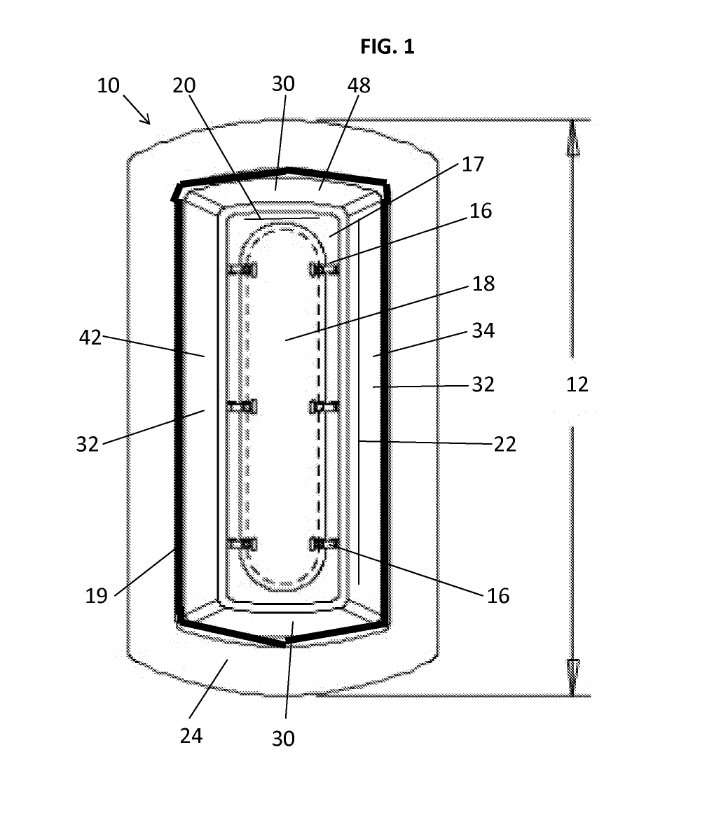

Referring first to FIG. 1, a perspective view of a first rib 10 of the present invention is provided. First rib 10 has a half-hexoid shape 16, a top end 20, and a base end 18. The top end 20 is where the first rib 10 will be sealed with another first rib 10 to form an arch 12 of a shelter structure 14, shown in FIG. 3. The base end 18 is securely attached to the top 46 of a pedestal 44, which is part of the base 42, indicated in FIG. 3, for example. The pedestal 44 also has a bottom 48, not visible in this view but understood to be the opposite side of the top 46, shown, and facing down toward the earth. The pedestal 44 has an inner side 52 that faces toward the inside of the shelter structure 14, and an outer side 54 that faces away from the shelter structure 14. The inner and outer sides 52, 54 are shown more clearly in FIG. 3. The top 46 of the pedestal 44 includes a lip 62, on which a floor segment 64 will rest, as shown in 3. The cross-section 30 of the rib 10 is visible at the top end 20 of the rib 10. The cross-section 30 has a convex half-hexagon shape 32, as discussed below with reference to FIGS. 5A and 5B.

The ribs of the present invention, whether first ribs 10, shown in FIG. 1, for example, or second ribs 80, shown in FIG. 8, for example, are made using a polyester resin with approximately 70% glass content. The preferred process used to mold the ribs is called the vacuum infusion process. With this process, all the glass is laid down in full thickness, a bag is placed over the entire rib, a full vacuum is drawn on the glass over the mold, and then the polyester resin is sucked into the laminate. This results in a bubble free very dense and very strong resilient laminate with E values more than twice that of structural hand-lay-up laminates. In addition, this is a closed molding process so that employees are not exposed to volatile organic compounds. Alternatively, the first and second ribs 10, 80 may be made of concrete.

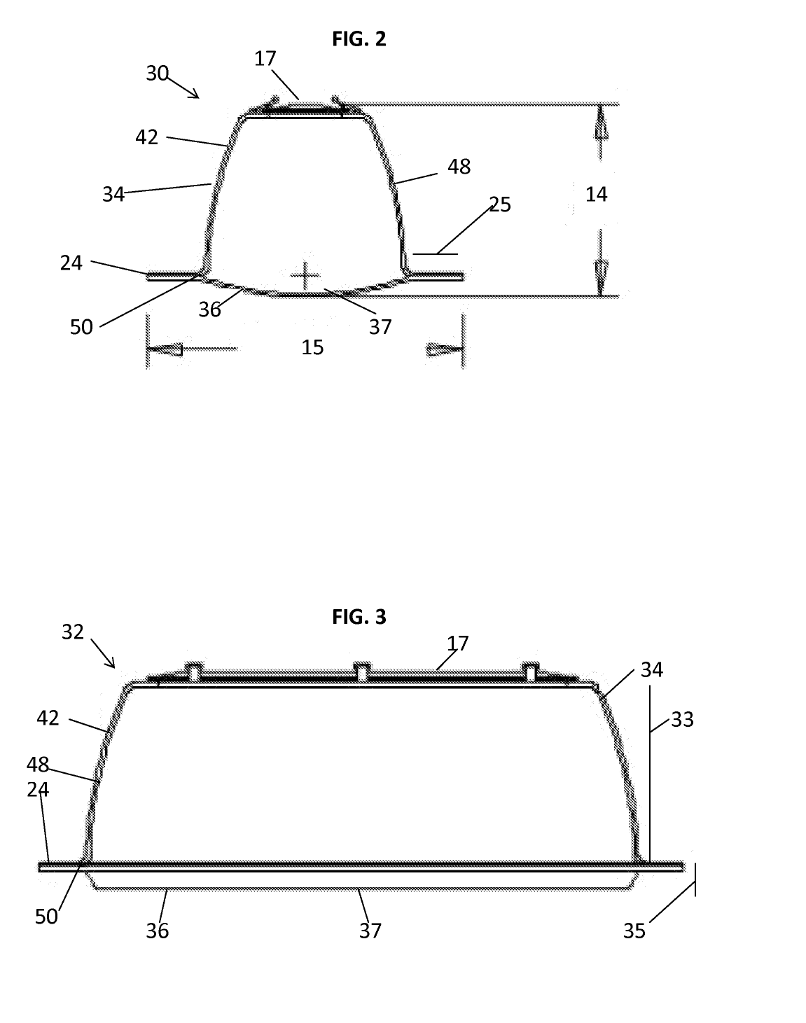

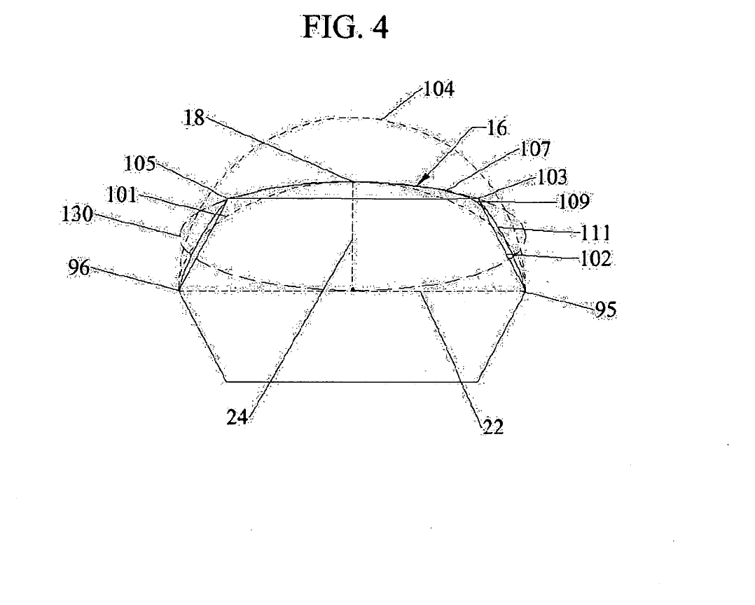

Now referring to FIGS. 2 and 3, front views of a prior art arch for a disaster shelter and a half-hexoid shelter structure 14 of the present invention are provided respectively. FIG. 2 shows a prior art elliptical arch. This arch is one piece, and its front view is either half-round or half-paraboloid, with the elliptical arch meeting the foundation at the neutral axis. FIG. 3 shows an arch 12 of the present invention, made up of two first ribs 10 of the present invention sealed at the top end 20 of the first ribs 10. The half-hexoid arch 12 in FIG. 3 is similar to the prior art arch in FIG. 2, but the elliptical shape of FIG. 2 has been pushed out to form the extruded elliptical/half-hexoid shape 16 of FIG. 3. This shape is explained in more detail with reference to FIG. 4. Each first rib 10 has a horizontal span 22 of fifty-two feet and a vertical height 24 of twenty feet. The dashed line in FIG. 3 indicates the shape of a prior art elliptical arch, as in FIG. 2.

The arch 12 shown in FIG. 3 sits upon a substructure 40. The substructure 40 includes a base 42, floor segments 64, a recess 66, and a plastic liner 67. The base 42 consists of a number of pedestals 44. The base ends 18 of the first ribs 10 are attached to the pedestals 44. Each pedestal 44 includes an inner side 52 and an outer side 54, as described above with reference to FIG. 1. Each pedestal has a height 50, a top 46, a bottom 48, and a lip 62 on the inner side 52 of the top 46. For every arch 12 in a shelter structure 14, the base 42 includes two pedestals 44 positioned on either side of the arch 12. Adjacent pedestals 44 supporting adjacent ribs 12 include a ¼ inch space 68 between them, indicated in FIG. 6.

Base 42 is precast concrete or made of composite. This is opposed to current, prior art bases made of fiberglass. Fiberglass is used at least on the tops 46 of pedestals 44, however, so as to create a gas tight surface, preventing radon and methane gas, commonly found in underground structures, from entering the shelter structure 14. The floor segments 64, shown in FIG. 3, are made of corrugated fiberglass or precast concrete. Floor segments 64 are made of two floor panels that meet in the middle of the floor. Floor segments 64 may be supported by piers 65. When the floor segments 64 are in position resting on lips 62 of pedestals 44, they are bolted together with gaskets, and all seams and gaps are sealed with a flexible sealant to create a gas tight foundation and floor. The recess 66 of the substructure 40 is defined by the floor segments 64 and the height 50 of the pedestals 44. This recess 66 is a crawl space that allows for important shelter infrastructure such as sewer lift stations, air ducts, plumbing, electrical lines, and sump pumps. A plastic liner 67 is placed at the bottom of recess 66 between bottoms 48 of pedestals 44 as an additional vapor barrier between the earth and the substructure 40. The plastic liner 67 also makes it easier and dryer for a person to crawl in the recess 66 when necessary.

The ¼ inch spaces 68 between the bases 42, shown most clearly in FIG. 6, allow water to enter into this recess 66. Making the bases 42 watertight would place a large uniform load on the floor. Specifically, for the preferred shelter structure 14 made of first ribs 10, the floor might be thirty feet below the ground. Making bases 42 watertight under these circumstances, by resisting hydrostatic pressure, the floor would see 13.2 psi, calculated from 30 ft*0.44 psi/ft. This would place a uniform load on the floor of 1,140,480 lbs, calculated from 50 ft span*12 ft*144 in²*13.2 psi. To support such a load would require a concrete slab many feet thick. As such, the inventor chose not to make the bases 42 watertight. The recess 66 created by the pedestals 44 and floor allows space for sump pumps that can pump water that has entered the recess up to the ground surface a long distance away. The bases 42 therefore do not need to be watertight. A thick slab of concrete under the structure is therefore avoided. This also allows for fast assembly in the field, as there is no need to wait for concrete to cure.

Now referring to FIG. 4, an illustration of how the extruded elliptical shape of ribs 10, 80 is formed is provided. The extruded elliptical/half-hexoid shape 16 of arch 12 is shown. Dashed line 104 is a half-circle, which is a common shape for prior art shelter structures. Dashed line 101 is the half-elliptical shape also common in prior art shelter structures, and the shape that is extruded to get the half-hexoid shape 16 of the present invention. Half-hexagon 102 is superimposed over half-ellipse 101. The hexagon of which the half-hexagon 102 is a half has all 120° angles. It is not a regular hexagon because its sides are not necessarily the same length. As shown, the longest distance between opposite vertices is equal to the major axis of the half-ellipse 101. This distance also corresponds with the span 22 of arch 12. Prior art half-ellipse 101 and half-hexoid shape 16 meet at top end 18. Half-ellipse 101, half-hexoid shape 16 of the present invention, and half-hexagon 102 all begin and end at right and left common end points 95, 96. Instead of following the curve of half-ellipse 101, however, half-hexoid 16 nearly intersects with right and left hexagon vertices 103, 105 on its way up to top end 18.

Ellipse 130 is included in FIG. 4 for purposes of illustration. The major axis of ellipse 130 has the same length as span 22 and the minor axis of ellipse 130 has the same length as height 24. Half-hexoid shape 16 has a top section 107 on either side of top end 18 that approximately follows the curve of ellipse 130 until it nearly meets right and left hexagon vertices 103, 105. This section of the half-hexoid shape 16 is the fillet blend section 109 where half-hexoid shape 16 turns downward away from ellipse 130 to more closely approximate the shape of half-hexagon 102. Fillet blend section 109 is a curved section that uses a fillet blend radius that is a blend of several radii to form half-hexoid shape 16. Side portion 111 is on either side between fillet blend section 109 and common end points 95, 96 and is also curved. As the half-hexoid shape 16 is guided by a half-hexagon, but is smooth and without flat surfaces or points, we call this shape a “half-hexoid” shape. It is understood that to get the shape used with second rib 80, a similar procedure is used, but with a full ellipse, and a full hexagon. Corresponding structures for second rib 80 are labeled in FIG. 8.

Now referring to FIGS. 5A and 5B, cross-sectional views of first and second ribs 10, 80 of the present invention are provided. Earth above the ribs 10, 80 is indicated by cross hatching. The shape of the rib cross-section 30 is a convex half-hexagon 32. In other words, the shape has three of six sides of a hexagon—two vertical curved walls 33 connected by one horizontal wall 35—but where all walls 33, 35 are convex, or curved outward. The arch cross-section 30 also includes a base flange 36 extending outwardly from the bottom of each vertical wall 33, and a lip flange 38 extending perpendicularly and upwardly from each base flange 36. Adjacent ribs 10, 80 are sealed to one another along their respective lip flanges 38. This design results in a stronger shape than prior art and uses only a small amount more material.

Cross-section 30 of first rib 10 has a width 34 of twelve feet, which is about ¼ the span of arch 12, which is preferably fifty-two feet, as discussed above. Cross-section 30 of second rib 80 has a width 34 of four feet, which is about ¼ the span of the second rib 80, which is preferably fourteen feet, as discussed in more detail with respect to FIG. 8 below. Having cross-section 30 be approximately ¼ of the span of arch 12 or second rib 80 has been shown to create an extremely strong structural element. The approximate ¼ ratio of cross-section width 34 to span is between 0.22 and 0.31. When referring to the vertical and horizontal walls 33, 35, we use the terms “vertical” and “horizontal” walls approximately. The vertical walls 33 are not perpendicular to the horizontal wall 35. In addition, neither the vertical walls 33, nor the horizontal wall 35 include any flat surfaces, as may be commonly implied by the terms “vertical” and “horizontal.” Because the vertical and horizontal walls 33, 35 do not include any flat surfaces, there are no tensile loads. As the earth loads put axial loads on the curved vertical wall 33, the thrust loads on the vertical wall 33 are resisted by the opposing and equal thrust loads from the adjacent vertical wall 33 so the shape is strong and stable. In this case, “adjacent” vertical walls 33 refer not to the two vertical walls 33 of a single cross-section 30, but to the closest vertical walls 33 of two cross-sections 30 of ribs 10, 80 that have been sealed together.

Now referring to FIG. 6, a perspective view of a half-hexoid shelter structure 14 of the present invention is provided. Shelter structure 14 sits on substructure 40, shown in FIG. 3, of which the outer sides 54 of the pedestals 44 of base 42 are visible. Base 42 also extends beneath the end panel 78 of shelter structure 14. Although not visible, a ¼ inch space 68 exists between each pedestal 44 of base 42. The shelter structure 14 shown includes eleven arches 12 and two end panels 78, the second end panel 78 not being visible in this view, but understood to be opposite from the visible end panel 78. It is understood that shelter structure 14 may include greater or less than eleven arches 12 in other embodiments. Each of the eleven arches 12 is made up of two first ribs 10 sealed at the top ends 20 of the first ribs 10. The sealing is achieved with a firm EPDM rubber gasket and bolts. This sealing is also used along the length of adjacent arches 12 at the lip flanges 38. Each arch 12 meets base 42 at the base ends 18 of first ribs 10. Holes are drilled into the pedestals 44 so that expanding anchor bolts may be used to secure the base ends 18 of first ribs 10 to pedestals 44. End panels 78 have a shape designed to match with the half-hexoid shape 16 of the first ribs 10.

Now referring to FIGS. 7 and 8, cutaway views of a prior art elliptical shelter 94 and a hexoid shelter structure 92 of the present invention are provided, respectively. Shelter structure 92 includes second rib 80, which is has a full extruded elliptical/hexoid shape, and is one piece. Although not shown, hexoid shelter structure 92 would include end panels to match with the shape of second rib 80. Second rib 80 has a convex half-hexagon cross-section 30 as described above with reference to FIGS. 5A and 5B. Each shelter structure 94, 92 has a span 82 of seven feet and a total height 84 of 5.5 feet.

FIG. 8 shows a front view of one second rib 80. A preferred shelter structure 92 of the present invention includes ten adjoined second ribs 80, where each second rib 80 has a cross-section width 34 of four feet on center, as discussed above with reference to FIGS. 5A and 5B. This preferred shelter structure 92 has approximately 5600 cubic feet of volume and has 544 square feet of floor space. Prior art shelter structure 94 with its traditional elliptical shape and ten ribs four feet on center has approximately 4200 cubic feet of volume and 400 square feet of floor space. The hexoid shelter 92 of the present invention is therefore approximately 30% bigger than its prior art elliptical counterpart 94, and is also approximately 30% stronger, while using only approximately 6% more material. Not only is there more space, but there is more usable space. Shelves 88, for example, are much closer to the wall of the second rib 80 in present invention shelter 92, thus minimizing the unusable space 90 between the wall and the shelves 88. It is understood that although it is preferred for present invention shelter 92 to include ten second ribs 80, some embodiments may include greater or fewer than ten second ribs 80. Floor 121 is also shown. Floor 121 is preferably positioned within total height 84 so that the ceiling within hexoid shelter 92 is approximately 8⅓ feet tall.

On the left of FIG. 8 structural components pertaining to how hexoid shape 119 is formed are shown. It is understood that its formation corresponds to what is described above with reference to FIG. 4, but including upper and lower portions, or that which is described above with reference to the half-hexoid shape 16 and its mirror image below it. The full hexoid shape 119 includes the top portion 107, upper side portion 111, and upper fillet blend section 109, as with the half-hexoid shape 16 shown in FIG. 4. The full hexoid shape 119 also includes bottom portion 113, lower side portion 115, and lower fillet blend portion 117, which are the lower mirror images of the upper counterparts shared with half-hexoid shape 16. Hexoid shape 119 is incorporated into second rib 80, which is one integrated piece. When considering the ellipse 130 the curve of which the bottom portions 113 and upper portions 107 will approximately follow, it is understood that the minor axis of ellipse 130 will be half of the total height 84 indicated, and the major axis of ellipse 130 is span 82. In other words, again hexoid shape 119 is equivalent to two half-hexoid shapes 16 as mirror images with the line of symmetry along span 22/82. To envision ellipse 130 as a tool for approximating at least the bottom portions 113 and upper portions 107 of hexoid shape 119, we would envision two ellipses 130 as mirror images, like a figure eight, with the line of symmetry along span 22/82. Therefore half-hexoid shape 16 pertaining to a single first rib, as described above, has a top portion 107 beginning at top end 18, a side portion 111 beginning at right or left end point 95, 96, and a fillet blend section 109 between and connecting the top portion 107 and the side portion 111.

Full hexoid shape 119, however, is the equivalent of four half-hexoid shapes 16. Full hexoid shape 119 therefore has an left top portion, an upper left fillet blend section, and an upper left side portion in the upper left quadrant of the shape; a right top portion, an upper right fillet blend section, and an upper right side portion in the upper right quadrant of the shape; a left bottom portion, a lower left fillet blend section, and a lower left side portion in the lower left quadrant of the shape; and a right bottom portion, a lower right fillet blend section, and a lower right side portion in the lower right quadrant of the shape. Top end 18, bottom end 132, and right and left end points 95, 96 are also shown. The right and left top portions both begin at top end 18. The upper right side portion and the lower right side portion both begin at right end point 95. The upper left side portion and the lower left side portion both begin at left end point 96. The right and left bottom portions both begin at bottom end 132.

The inner layer 26 of the ribs contains a fine solid copper mesh 28, as indicated in FIGS. 5A and 8. The copper mesh 28 has at least twelve strands per inch, is preferably 16 mesh solid copper, and is typically used for electromagnetic fields and RF frequencies. The copper mesh 28 is approximately 0.060 inches from the inside surface 123 of the shelter hull, shown in FIGS. 1 and 8. The inclusion of the copper mesh 28 provides an EMP shield in the E1, E2, and E3 bands from an electromagnetic pulse weapon. The copper mesh 28 acts as a shield to the most dangerous portion of the EMP spectrum, which is 100-3000 MHz, and has an 80+ Db attenuation, not counting the 8.5 feet of earth cover over the shelter structure. Some prior art shelter structures use steel as an EMP shield. The copper mesh 28 is preferable to steel because it is 8.5 times more conductive, and does not corrode like steel resulting in a stable EMP shield over long periods of time with no deterioration and maintenance. In addition, it does not suffer the imminent corrosion of the welds, leading to holes in the welds, which break the Faraday cage envelope. Also, titanium dioxide is added to the resin to increase the conductivity of the polyester-resin laminate. With a thin layer of polyester on the inside of the copper mesh 28 facing the inside of the shelter 14, 92, Mission Essential Equipment (MEE) are insulated from further damage if it is located against or near the shelter wall. The best Faraday cage or EMP shielded underground shelter has some form of copper shielding on the outside surface facing the EMP source with some type of insulator on the inside surface of the copper shield facing inside the shelter protecting the electronic equipment inside the shelter. The laminate used to manufacture the shelter hulls and entranceways is designed to meet MIL-STD-188-125-1. In addition, shelter structures 14, 92, as well as the inventor's other structures, have been reviewed for an EMP Protection Analysis by a Certified Electromagnetic Compatibility Engineer and a Certified Electrostatic Discharge Control Engineer.

The vacuum infused structural composite shelter hull and entranceway have a CPI (Copper Plastic Insulated) EMP Shield. Copper, with a conductivity of 60,000,000 Siemens/m is almost nine times more conductive than carbon steel which has a conductivity of 7,000,000 Siemens/m making it the strongest EMP shield used to protect military MEE. Unlike steel, copper shielding infused in the structural composite laminate is corrosion resistant so the level of EMP shielding does not deteriorate over time. It therefore does not require monthly maintenance and testing to be compliant with MIL-STD-188-125-1. The copper shield has a plastic layer facing the shelter interior to further protect the MEE that might be located near the shelter hull wall. The 20 psi external pressure resistance above the static earth load, with no earth arching, is constant over the first 150 years. The CPI Composite also forms a complete vapor barrier which provides a dry atmosphere when placed below ground. In addition, one of the greatest characteristics of the CPI Composite is its resiliency or ability to “remain intact” if overstressed. The inside of the shelter is smooth, curved, and white to create maximum brightness with minimal light. All of these facilities function without outside electricity through the use of an internal diesel generator, battery bank, and DC charger/AC inverter. The inside surface is easily cleaned with common detergents and is easily repaired and there is ample volume for food storage under the floor.

All of the shelter structures described herein are shielded by the CPI Composite hull and entranceway. The radio antennas should not be connected to the radios prior to an EMP event. In military operations, where the radios need to be connected to the antennas and operational prior to an EMP event, backup radios need to be stored unconnected and kept in the shelter. The shelter structures of the present invention are designed to operate off grid with internal generators so they are not subject to EMP collected on the power grid. The power cable from the shelter to the dedicated well and the well water hose to the shelter are both underground and shielded.

The half-hexoid shelter structure 14 and hexoid shelter structure 92, shown in FIGS. 3 and 8 respectively are well adapted for high external static and dynamic loads, such as earth. Many structures in many fields, such as siding and roofing materials, include ribs. Such ribs are very small, however, so that many ribs are used for each panel, and all the ribs have straight walls. These straight walled ribs are not adapted for high static loads. The tops of the shelter structures 14, 92 are convex. As shown in FIGS. 3 and 5A, each rib 10, 80, is curved across its entire length and depth. As such, the hulls of the shelter structures 14, 92 made of these ribs 10, 80 are not extrudable. As shown in FIG. 6, the shape of the end panels 78 also do not include flat surfaces, so that the end panels 78 are also designed to resist buckling loads.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

1. A munitions vault adapted for use underground comprising:
a watertight, non-corrosive hull, said hull comprising:
an upper section comprising a top, two short sides, and two long sides, wherein each of said two short sides and two long sides comprises a hexoid shape, and said upper section comprises no flat surfaces;
a lower section comprising a bottom; and
a gravity ring spanning a circumference of said vault between said upper and lower sections.

2. The munitions vault as claimed in claim 1, further comprising a total length of between 64 and 70 inches.

3. The munitions vault as claimed in claim 1, further comprising a total height of between 20 and 24 inches.

4. The munitions vault as claimed in claim 1, further comprising a total width of between 34 and 38 inches.

5. The munitions vault as claimed in claim 1, wherein said top of said upper section comprises an oval-shaped cover comprising a length of between 39 and 43 inches, a width of between 8 and 10 inches, and at least four pull latches.

6. The munitions vault as claimed in claim 1, wherein said bottom of said lower section is convex.

7. The munitions vault as claimed in claim 6, wherein said bottom of said lower section has a depth of 2 inches.

8. The munitions vault as claimed in claim 1, wherein said hull is manufactured from a composite material.

9. The munitions vault as claimed in claim 1, wherein said upper and lower sections are bonded to one another with a plastic flexible seal such that said seal is watertight.

10. The munitions vault as claimed in claim 1, wherein said upper and lower sections are formed using a vacuum infusion process.

11. The munitions vault as claimed in claim 1, wherein said upper section comprises a height of 20 inches.

12. The munitions vault as claimed in claim 1, wherein said gravity ring comprises a width wide enough such that said gravity ring creates at least 1.2 times a downward gravity in comparison with a hydrostatic pressure created by displacement of water by said munitions vault.

13. The munitions vault as claimed in claim 1, wherein said gravity ring comprises a width of 6 inches.

14. The munitions vault as claimed in claim 1, wherein said hull of said vault is shaped and dimensioned to be capable of:
securing up to 2000 pounds of material;
containing 11.5 cubic feet of space;
withstanding up to 10 psi of pressure; and
withstanding a disturbance of up to 8.5 on the Richter scale.

15. The munitions vault as claimed in claim 1, wherein said hull further comprises an EMP shield.

16. The munitions vault as claimed in claim 15, wherein said EMP shield is a fine copper mesh.

17. A munitions vault adapted for use underground comprising:
a watertight, non-corrosive, composite hull, said hull comprising:
an upper section comprising a top, two short sides, and two long sides, wherein each of said two short sides and two long sides comprises a hexoid shape and said upper section comprises no flat surfaces;
a lower section comprising a convex bottom;
a gravity ring spanning a circumference between said upper and lower sections, comprising a width of 6 inches;
wherein said upper and lower sections are bonded to one another with a plastic flexible seal; and
wherein said upper and lower sections are formed using a vacuum infusion process; and
a total length of 67 inches;
a total height of 22 inches; and
a total width of 36 inches.

18. The munitions vault as claimed in claim 17, wherein said top of said upper section comprises an oval-shaped cover comprising a length of 41 inches, a width of 8.75 inches, and at least four pull latches.

19. The munitions vault as claimed in claim 17, wherein said composite hull further comprises an EMP shield.
